(19) United States
(12) Patent Application Publication
(10) Pub. No.: US 2016/0124417 A1
(43) Pub. Date: May 5, 2016

(54) AUTOMATIC GAIN ADJUSTMENT SUPPORT DEVICE

(71) Applicant: FANUC Corporation, Yamanashi (JP)

(72) Inventors: Hajime OGAWA, Yamanashi (JP); Junichi TEZUKA, Yamanashi (JP)

(21) Appl. No.: 14/922,257

(22) Filed: Oct. 26, 2015

(30) Foreign Application Priority Data
Oct. 31, 2014 (JP) 2014-223482

(51) Int. Cl. G05B 19/19

(52) U.S. Cl. CPC G05B 19/19

(57) ABSTRACT

An automatic gain adjustment support device according to this invention supports automatic adjustment of a control gain in a control loop for a servomotor controller which controls a servomotor. The automatic gain adjustment support device includes a frequency characteristic measuring unit, a display unit, a condition setting unit, an automatic gain adjusting unit, and a parameter setting unit. The frequency characteristic measuring unit measures frequency characteristics of the control loop in the servomotor controller. The display unit displays, in Bode diagram form, the frequency characteristics of the control loop. The condition setting unit sets a target gain value at a predetermined frequency. The automatic gain adjusting unit automatically adjusts the control gain in the control loop to the target gain value at the predetermined frequency set by the condition setting unit. The parameter setting unit sets the control gain to the servomotor controller.

### BACKGROUND OF THE INVENTION

1. Field of the Invention

The present invention relates to an automatic gain adjustment support device which automatically adjusts the control gain in a servomotor controller which controls a servomotor.

2. Description of the Related Art

In a servomotor controller which controls a servomotor, it is important to determine a control gain in accordance with the object to be driven in order to improve the response characteristics of a control loop. One common adjusting method is known to perform analysis based on the frequency response method, observe gain margin and phase margin in the gain characteristics, and adjust the control gain with reference to their values.

The conventional automatic gain adjusting device employs a method for adjusting the control gain so that the gain margin in the phase crossover frequency reaches a preset value, or a method for adjusting the control gain so that the phase margin in the gain crossover frequency reaches a preset value.

Known examples include a servomotor controller having an automatic gain adjusting function (see Japanese Laid-open Patent Publication No. 2009-165258 (JP 2009-165258 A; referred to as “Patent Literature 1” hereinafter). With this function, an adjustment multiplier of the control gain is calculated from the ratio between an input-output gain and a target gain value in analyzing the control loop using the frequency response method, and is multiplied by a correction coefficient to obtain a new adjustment multiplier, which is applied to the servomotor controller to obtain frequency characteristics close to the target gain value.

Patent Literature 1 describes a method for adjusting the adjustment multiplier of the control gain. However, Patent Literature 1 does not describe a technique for setting a target gain value by the operator to perform automatic adjustment. Therefore, even when, for example, the object to be driven has low rigidity or the gain is preferably set relatively low, the gain may be set high, resulting in oscillation.

Another method is known to perform automatic adjustment in accordance with a predetermined reference value (a phase margin φ in the gain crossover frequency and a gain margin in the phase crossover frequency) (see Japanese Patent No. 5220475 (JP 5220475 B); to be referred to as “Patent Literature 2” hereinafter). In the conventional technique described in Patent Literature 2, no sufficient gain margin may be obtained in a frequency range other than the fitted frequencies, resulting in oscillation.

Conventional automatic adjustment of the control gain, for improving the response characteristics of the control loop will be described below. FIG. 1 is a block diagram illustrating a conventional speed controller. A speed controller 200 adds, a value obtained by multiplying the integral of a speed error that is the difference between a speed command value and a speed detection value by a speed integral gain (Ki) 202, to a value obtained by multiplying the speed error by a speed proportional gain (Kp) 201, and multiplies the obtained sum by a predetermined adjustment multiplier (D) 203 to output a torque command. The torque command is converted into an actual speed of a servomotor by transfer characteristics (1/(J·s)) 204. In a speed loop illustrated as FIG. 1, the speed proportional gain Kp, the speed integral gain Ki, and the adjustment multiplier D serve as control gains, which are adjusted so as to improve the response characteristics of the speed loop (control loop).

In automatic adjustment, a disturbance having a predetermined frequency is input as an input signal (speed command), and the frequency characteristics (Bode diagram) of a control loop (speed loop) are calculated from the input signal (speed command) and an output signal (actual speed) to automatically adjust the control gain so that the gain in a frequency which satisfies a predetermined condition becomes equal to a predetermined target gain value.

For example, FIGS. 2A and 2B are Bode diagrams of the gain (Gain (db)) and phase (Phase (deg)), respectively, before automatic adjustment, and FIGS. 2C and 2D are Bode diagrams of the gain and phase, respectively, after automatic adjustment. As an example, the control gain is adjusted so that the gain margin in the phase crossover frequency becomes −3 db.

In the conventional automatic adjustment, it is difficult to finely set a target gain value in accordance with the rigidity of the object to be driven or how it is used. It is also difficult to check how the target gain value is set.

Hence, when the control gain after automatic adjustment is applied to a servomotor controller, if the object to be driven has low rigidity, oscillation may occur. In addition, even when high responsibility is not necessary, the response characteristics may be set high, thus leading to instability.

### SUMMARY OF INVENTION

The conventional automatic gain adjusting device adjusts the control gain in accordance with a preset target gain value, and disadvantageously causes oscillation when the object to be driven has low rigidity.

An automatic gain adjustment support device according to one embodiment of the present invention supports automatic adjustment of a control gain in a control loop for a servomotor controller which controls a servomotor. The automatic gain adjustment support device includes a frequency characteristic measuring unit, a display unit, a condition setting unit, an automatic gain adjusting unit, and a parameter setting unit. The frequency characteristic measuring unit measures frequency characteristics of the control loop in the servomotor controller. The display unit displays, in the form of a Bode diagram, the frequency characteristics of the control loop measured by the frequency characteristic measuring unit. The condition setting unit sets a target gain value at a predetermined frequency on the Bode diagram of the frequency characteristics of the control loop displayed on the display unit. The automatic gain adjusting unit automatically adjusts the control gain in the control loop to the target gain value at the predetermined frequency set by the condition setting unit. The parameter setting unit sets the control gain adjusted by the automatic gain adjusting unit to the servomotor controller.

### BRIEF DESCRIPTION OF THE DRAWINGS

The above and other objects, features, and advantages of the present invention will be more apparent from the following description of embodiments when taken in conjunction with the accompanying drawings, in which:

FIG. 1 is a block diagram illustrating the conventional speed controller;

FIG. 2A is a Bode diagram of the gain before filter adjustment in the conventional servomotor controller;

FIG. 2B is a Bode diagram of the phase before filter adjustment in the conventional servomotor controller;

FIG. 2C is a Bode diagram of the gain after filter adjustment in the conventional servomotor controller;

FIG. 2D is a Bode diagram of the phase after filter adjustment in the conventional servomotor controller;

FIG. 3 is a block diagram illustrating an automatic gain adjustment support device according to an embodiment of the present invention;

FIG. 4 is a flowchart for explaining an exemplary operation procedure of the automatic gain adjustment support device according to the embodiment of the present invention;

FIG. 5A is a Bode diagram of the gain before filter adjustment in the automatic gain adjustment support device according to the embodiment of the present invention;

FIG. 5B is a Bode diagram of the phase before filter adjustment in the automatic gain adjustment support device according to the embodiment of the present invention;

FIG. 5C is a Bode diagram of the gain after filter adjustment in the automatic gain adjustment support device according to the embodiment of the present invention;

FIG. 5D is a Bode diagram of the phase after filter adjustment in the automatic gain adjustment support device according to the embodiment of the present invention;

FIG. 6A is a Bode diagram of the gain when a target gain value is selected in the automatic gain adjustment support device according to the embodiment of the present invention;

FIG. 6B is a Bode diagram of the phase when a target gain value is selected in the automatic gain adjustment support device according to the embodiment of the present invention;

FIG. 7A is a Bode diagram of the gain before and after adjustment in the automatic gain adjustment support device according to the embodiment of the present invention; and

FIG. 7B is a Bode diagram of the phase before and after adjustment in the automatic gain adjustment support device according to the embodiment of the present invention.

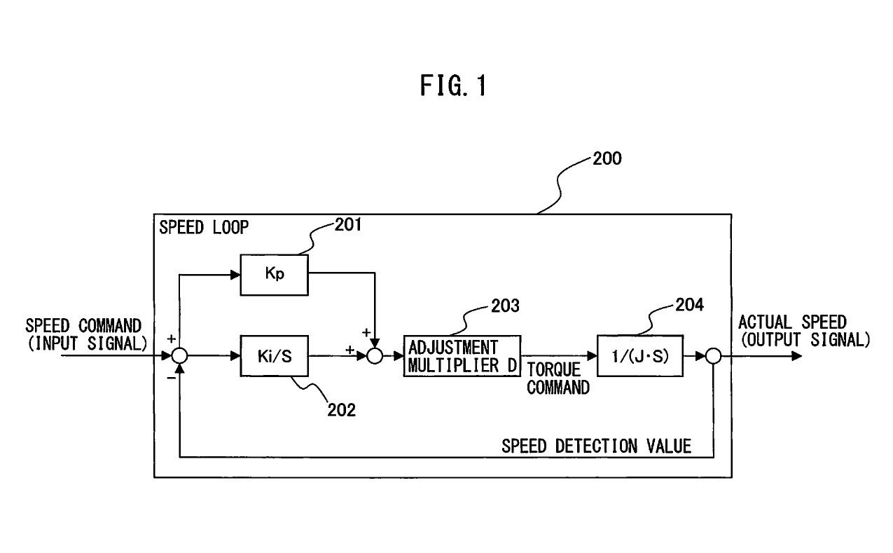

### DETAILED DESCRIPTION

An automatic gain adjustment support device according to the present invention will be described below with reference to the drawings. However, is should be note that the technical scope of the present invention is not limited to embodiments of the present invention, and covers the invention defined by the scope of claims, as well as equivalents to the claims.

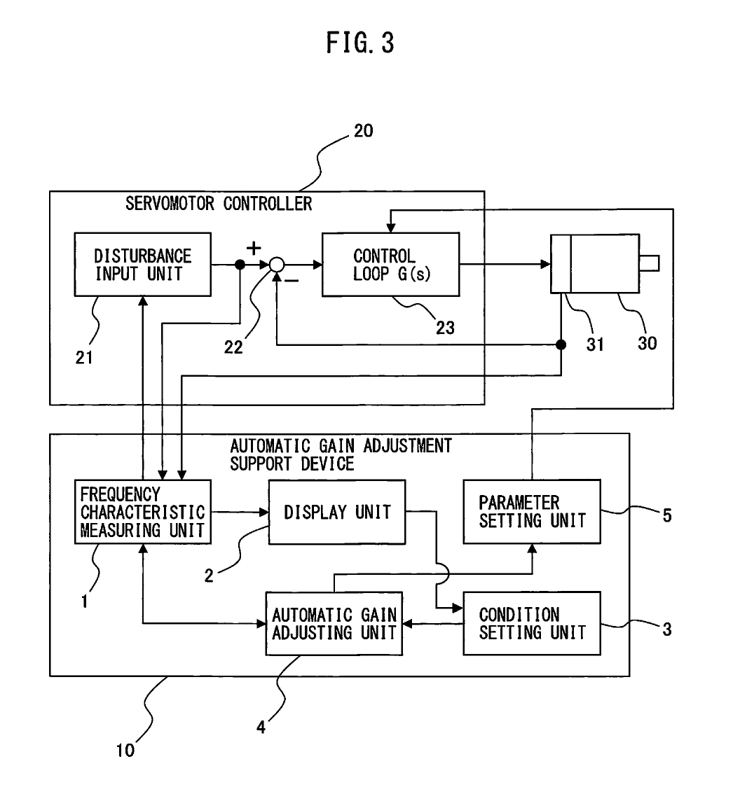

An exemplary configuration of an automatic gain adjustment support device according to an embodiment of the present invention will be described first with reference to the drawings. FIG. 3 is a block diagram illustrating an exemplary configuration of an automatic gain adjustment support device according to an embodiment of the present invention. An automatic gain adjustment support device 10 according to the embodiment of the present invention supports automatic adjustment of a control gain in a control loop 23 for a servomotor controller 20 which controls a servomotor 30. The automatic gain adjustment support device 10 includes a frequency characteristic measuring unit 1, a display unit 2, a condition setting unit 3, an automatic gain adjusting unit 4, and a parameter setting unit 5.

The frequency characteristic measuring unit 1 measures frequency characteristics of the control loop 23 of the servomotor controller 20. The frequency characteristic measuring unit 1 measures a speed command and a speed feedback while adding a disturbance (e.g., a sinusoidal wave) having a predetermined frequency to the speed command of the control loop 23. The measured speed command and the speed feedback are transformed by FFT to calculate a gain and phase representing the frequency characteristics of a transfer function.

The display unit 2 obtains, from the frequency characteristic measuring unit 1, the frequency characteristic data of the control loop 23 measured by the frequency characteristic measuring unit 1 and displays the frequency characteristics of the control loop 23 in Bode diagram form. The display unit 2 can be implemented in a display device, capable of displaying a Bode diagram, such as a liquid crystal display device or an organic EL display device. The display unit 2 may include a touch panel to be capable of receiving externally input data while displaying a Bode diagram. The data externally input to the display unit 2 is sent to the condition setting unit 3.

The condition setting unit 3 sets a target gain value at a predetermined frequency on the Bode diagram of the frequency characteristics of the control loop 23 displayed on the display unit 2. More specifically, when a target gain value at a predetermined frequency is selected on the Bode diagram displayed on the display unit 2, using an input device (not illustrated) such as a touch panel or a mouse, the selected target value is sent from the display unit 2 to the condition setting unit 3. With this operation, a target gain value is set for automatic adjustment executed by the automatic gain adjusting unit 4. Alternatively, an input device (not illustrated), such as a keyboard, for setting a target gain value at a predetermined frequency may be provided. The condition setting unit 3 may set a gain value at the predetermined frequency selected on the Bode diagram as the target gain value.

The automatic gain adjusting unit 4 automatically adjusts the control gain of the control loop 23 to the target gain value at the predetermined frequency set by the condition setting unit 3. When a value obtained by multiplying the control gain by an adjustment multiplier is set as a new control gain, the automatic gain adjusting unit 4 may automatically adjust the adjustment multiplier in a control loop to the target gain value at the predetermined frequency. A method for automatically adjusting the control gain of a control loop will be described later.

The parameter setting unit 5 sets the control gain adjusted by the automatic gain adjusting unit 4 to the servomotor controller 20.

The servomotor controller 20 includes a disturbance input unit 21, a subtractor 22, and the control loop 23. The disturbance input unit 21 adds a disturbance having a predetermined frequency to a speed command value. The control loop 23 adds, a value obtained by multiplying the integral of a speed error that is the difference between a speed command value and a speed detection value detected by an encoder 31 mounted in the servomotor 30 by a speed integral gain, to a value obtained by multiplying the speed error by a speed proportional gain, and multiplies the obtained sum by a predetermined adjustment multiplier to output a torque command.

An exemplary operation procedure of the automatic gain adjustment support device according to the embodiment of the present invention will be described next. For the sake of simplicity, an arithmetic constant within the control loop and an arithmetic constant multiplied by the adjustment multiplier will be referred to as control gains hereinafter. Although a speed loop having a speed command as an input signal and an actual speed as an output signal is referred to herein as an exemplary control loop, the same applies to a current loop having a current command as an input signal and an actual current as an output signal and a position loop having a position command as an input signal and an actual position as an output signal.

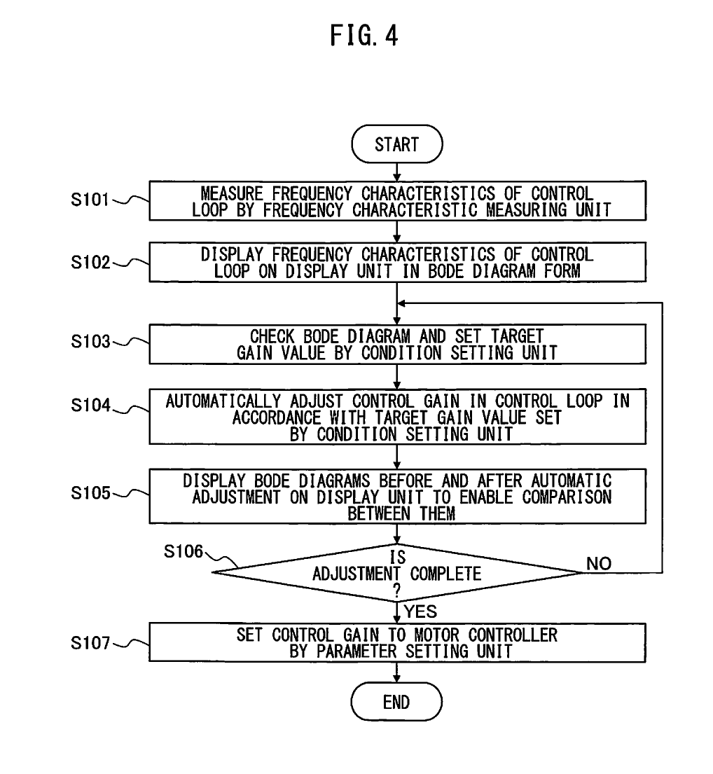

To solve the above-mentioned problem in the conventional technique, a target gain value for automatic adjustment can be flexibly set by the condition setting unit 3 in accordance with the frequency characteristics of the object to be driven, on the Bode diagram displayed on the display unit 2. More specifically, adjustment is performed in accordance with the following sequence of a flowchart illustrated as FIG. 4.

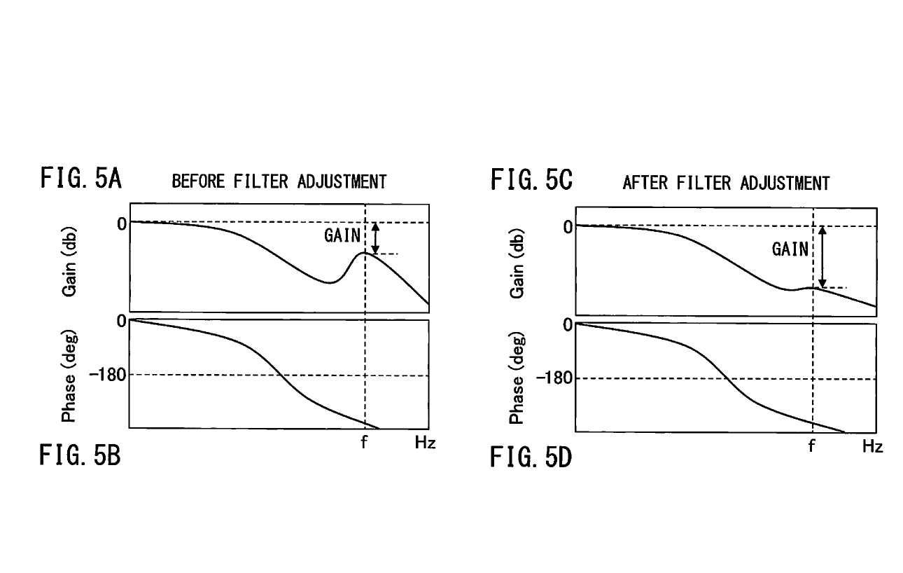

First, in step S101, automatic adjustment is started and frequency characteristics (Bode diagram) of the control loop 23 are measured by an initial set control gain. The frequency characteristic are measured by the frequency characteristic measuring unit 1 and a command is issued to input a disturbance (e.g., a sinusoidal wave) having a predetermined frequency to the disturbance input unit 21 of the servomotor controller 20 in order to oscillate the control loop 23. The frequency characteristics (Bode diagram) are calculated based on the relationship between the input and output signals of the control loop 23. FIGS. 5A and 5B illustrate exemplary calculated Bode diagrams. FIG. 5A depicts the frequency characteristics of the gain before filter adjustment, and FIG. 5B depicts the frequency characteristics of the phase before filter adjustment.

In step S102, the frequency characteristics of the control loop 23 are displayed on the display unit 2 in Bode diagram form. The operator observes the Bode diagram displayed on the display unit 2 to check a rise (e.g., mechanical resonance) of the gain characteristics, as represented as FIG. 5A, and also check the difference of a gain at a predetermined frequency f and 0 db (FIG. 5B). In doing this, filter adjustment (adjustment of a notch filter or a low-pass filter) for a rise (e.g., mechanical resonance) of the gain characteristics, as illustrated as FIG. 5C, allows the input-output gain to be set high in the subsequent process.

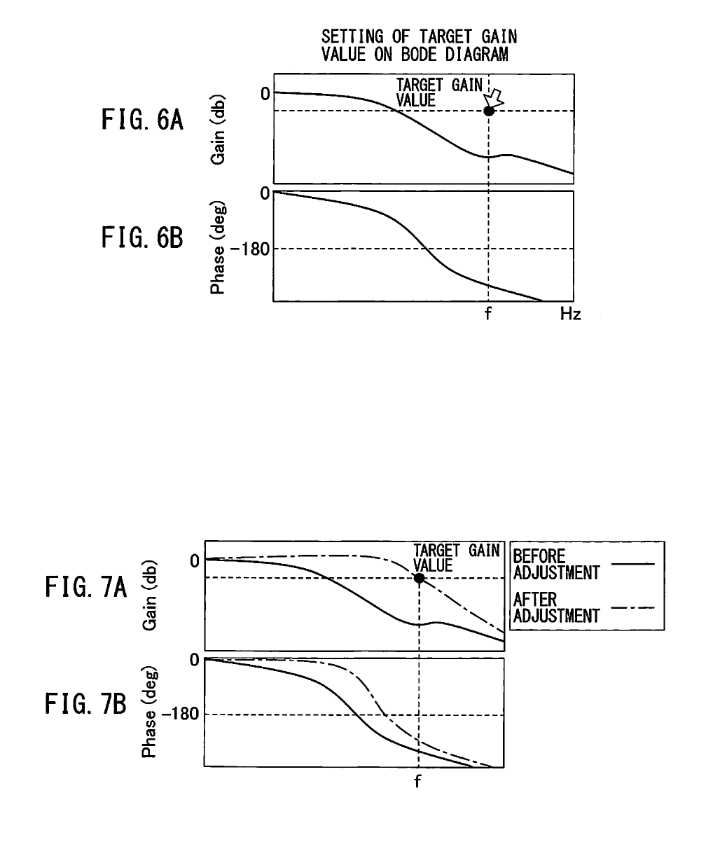

In step S103, the Bode diagram displayed on the display unit 2 is checked to set, by the condition setting unit 3, a target gain value for automatic adjustment. The operator selects a target gain value at a predetermined frequency on the Bode diagram displayed on the display unit 2, using a touch panel or a mouse (neither is illustrated), as depicted as FIG. 6A. The selected target value is sent from the display unit 2 to the condition setting unit 3. With this operation, the condition setting unit 3 sets a target gain value for automatic adjustment executed by the automatic gain adjusting unit 4. A target gain value may be input using an input device such as a keyboard.

In step S104, the automatic gain adjusting unit 4 automatically adjusts the control gain of the control loop 23 in accordance with the target gain value set by the condition setting unit 3. Two concrete techniques for automatic adjustment will be described hereinafter.

The first technique oscillates the control loop 23 while changing the control gain in steps of a predetermined value and adjusts the control gain to the target gain value at the predetermined frequency f set by the condition setting unit 3. In this case, the control gain may be set with a little margin for the set value.

The second technique calculates the rate of change in control gain based on the ratio between the gain characteristics at an initial set value of the control gain and the target value of the gain characteristics and sets a value obtained by multiplying the control gain by the obtained rate of change, as a control gain.

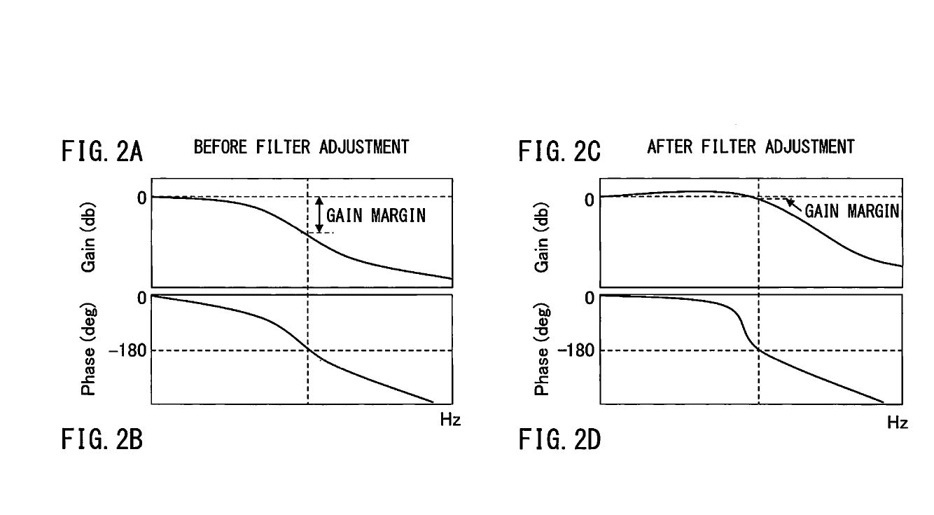

In step S105, the display unit 2 displays the Bode diagrams before and after automatic adjustment to enable a comparison between them. The sets of frequency characteristics before and after automatic adjustment can be compared with each other by, for example, displaying the Bode diagrams before and after adjustment side by side, as depicted as FIGS. 2A to 2D. Alternatively, the effect of adjustment can easily be determined by, for example, superimposing the Bode diagrams before and after adjustment on each other, using a solid line for data before automatic adjustment and an alternate long and short dashed line for data after automatic adjustment, as depicted as FIGS. 7A and 7B.

In step S106, the automatic gain adjusting unit 4 checks the control gain after automatic adjustment to determine whether the adjustment is complete. If it can be determined that the adjustment is complete without any problem, in step S107 the control gain is set to the servomotor controller 20 by the parameter setting unit 5 and the automatic adjustment is completed. On the other hand, if it cannot be determined that the adjustment is complete due to any problem, the procedure returns to step S103, in which the processes in steps S103 to S105 are repeated.

As described above, the automatic gain adjustment support device according to the embodiment of the present invention includes a display unit and a condition setting unit for enabling the operator to flexibly set a target gain value while observing Bode diagrams, instead of giving a target gain value as the criterion of automatic adjustment in advance. This allows optimum automatic gain adjustment corresponding to the object to be driven, without oscillation.

The automatic gain adjustment support device according to one embodiment of the present invention allows optimum automatic gain adjustment corresponding to the object to be driven, without oscillation.

What is claimed is:

1. An automatic gain adjustment support device which supports automatic adjustment of a control gain in a control loop for a servomotor controller which controls a servomotor, the automatic gain adjustment support device comprising:
a frequency characteristic measuring unit configured to measure a frequency characteristic of the control loop in the servomotor controller;
a display unit configured to display, in form of a Bode diagram, the frequency characteristic of the control loop measured by the frequency characteristic measuring unit;
a condition setting unit configured to set a target gain value at a predetermined frequency on the Bode diagram of the frequency characteristic of the control loop displayed on the display unit;
an automatic gain adjusting unit configured to automatically adjust the control gain in the control loop to the target gain value at the predetermined frequency set by the condition setting unit; and
a parameter setting unit configured to set the control gain adjusted by the automatic gain adjusting unit to the servomotor controller.

2. The automatic gain adjustment support device according to claim 1, wherein the condition setting unit sets a gain value at the predetermined frequency selected on the Bode diagram as the target gain value.

3. The automatic gain adjustment support device according to claim 1, wherein the Bode diagram comprises Bode diagrams before and after automatic adjustment and the display unit displays the Bode diagrams to enable a comparison therebetween.

4. The automatic gain adjustment support device according to claim 1, wherein when a value obtained by multiplying the control gain by an adjustment multiplier is set as a new control gain, the automatic gain adjusting unit automatically adjusts the adjustment multiplier of the control loop to the target gain value at the predetermined frequency.
